(19) United States
(12) Patent Application Publication
(10) Pub. No.: US 2016/0133350 A1
(43) Pub. Date: May 12, 2016

(54) CONDUCTIVE RESIN COMPOSITION FOR MICROWAVE HEATING

(71) Applicant: SHOWA DENKO K.K., Tokyo (JP)

(72) Inventors: Hiroshi UCHIDA, Tokyo (JP); Shoichiro WAKABAYASHI, Tokyo (JP); Masanao HARA, Tokyo (JP); Jun DOU, Tokyo (JP)

(73) Assignee: SHOWA DENKO K.K., Tokyo (JP)

(21) Appl. No.: 14/895,225

(22) PCT Filed: May 29, 2014
(86) PCT No.: PCT/JP2014/064277

§ 371 Date: Dec. 2, 2015

(30) Foreign Application Priority Data
Jun. 3, 2013 (JP) 2013-116824

(51) Int. Cl. H01B 1/22; H01B 13/00

(52) U.S. Cl. CPC H01B 1/22; H01B 13/003

(57) ABSTRACT

Provided is a conductive resin composition for microwave heating capable of suppressing the generation of sparks when microwave heating is performed. A conductive resin composition for microwave heating comprising a non-carbonaceous conductive filler, a curable and insulating binder resin, and a carbonaceous material having a higher volume resistivity value than the non-carbonaceous conductive filler, the carbonaceous material having an aspect ratio of 20 or less, and the content of the carbonaceous material being 1 to 20 parts by mass, relative to the total of 100 parts by mass of the non-carbonaceous conductive filler and the curable and insulating binder resin. The carbonaceous material efficiently absorbs the microwave, and thus, when the microwave is irradiated to heat and cure the conductive resin composition, generation of sparks can be suppressed.

### TECHNICAL FIELD

The present disclosure relates to a conductive resin composition. In more detail, the present disclosure relates to a conductive resin composition suitable for being cured by microwave heating.

### BACKGROUND ART

There is a known technology of heating a material such as metal, or a thin film thereof, using microwave. When the microwave is used, due to the effect of an electric field or a magnetic field, an object can be selectively heated.

As an example of microwave heating, Patent Document 1 (in particular, paragraph 0073, etc.) discloses a technology of irradiating a microwave to a thin film formed from an inorganic metal salt material which is a precursor of a metal oxide semiconductor, under an atmospheric pressure (in the presence of oxygen), to convert the thin film to a semiconductor.

Further, Patent Document 2 (in particular, paragraph 0024, etc.) discloses a technology of heating an object to be processed, such as a cutting-plate made of hard metal, cermet, or ceramic, while the object is passed through a tunnel provided with microwave sources (magnetron) arranged at equal intervals.

Patent Document 3 (in particular, paragraph 0019, etc.) discloses a microwave heating apparatus which is provided with a grind stone material installed at a position where an electric field or a magnetic field of a standing wave (combinations of incident waves and reflected waves) is maximum, so that heating of the material can efficiently be performed.

Further, Patent Document 4 (in particular, paragraphs 0042, 0048, etc.) discloses a technology of surface-coating or patterning of metal particles on a substrate, selectively heating the particles by irradiating high-frequency electromagnetic wave at a predetermined frequency, and forming a complicated surface-mounted electronic component by mutually fusing the metal particles. Also disclosed is a feature that the selective heating property can be made stronger by mixing a sintering aid superior in a high-frequency electromagnetic wave absorption property, such as a carbon material, to the metal particles.

Further, Patent Document 5 (in particular, paragraph 0045, etc.) discloses a new curable paint composition which can be cured by microwave irradiation, the paint composition comprising a conductive filler (a) having an aspect ratio of 5 or more, a binder (b), a solvent (c), and a pigment (d).

### PRIOR ARTS

### Patent Document

Patent Document 1: Japanese Unexamined Patent Publication (Kokai) No. 2009-177149

Patent Document 2: Japanese Unexamined Patent Publication (Kokai) No. 2006-300509

Patent Document 3: Japanese Unexamined Patent Publication (Kokai) No. 2010-274383

Patent Document 4: Japanese Unexamined Patent Publication (Kokai) No. 2006-269984

Patent Document 5: Japanese Unexamined Patent Publication (Kokai) No. 2003-64314

### SUMMARY

In general, there is a drawback that, when a conductor or semiconductor film, or a dispersion film having dispersed conductors or semiconductors, is heated by microwave, such a film or a substrate provided with such a film may be broken by the generation of sparks, and thus, appropriate heating is difficult. The above-mentioned Patent Documents 1 to 5 do not disclose nor suggest such a drawback. Patent Document 4 discloses a paste including silver nano particles and a carbon material, but a detailed composition thereof is not disclosed. Patent Document 5 only discloses a metal material and a carbon material equally, as exemplified examples of a conductive filler.

One of the objectives of the present disclosure is to provide a conductive resin composition for microwave heating capable of presenting a high conductivity when the composition is cured, and capable of being heated and cured uniformly in a short time while suppressing the generation of sparks.

In order to attain the above objectives, an aspect of the present disclosure is a conductive resin composition for microwave heating comprising a non-carbonaceous conductive filler, a curable and insulating binder resin, and a carbonaceous material having a higher volume resistivity value than the non-carbonaceous conductive filler, the carbonaceous material having an aspect ratio of 20 or less, and the content of the carbonaceous material being 1 to 20 parts by mass, relative to the total of 100 parts by mass of the non-carbonaceous conductive filler and the curable and insulating binder resin. Preferably, the carbonaceous material is a graphite particle.

The non-carbonaceous conductive filler is a particle or a fiber made of at least one kind of metal, or an alloy of a plurality of kinds of metal selected from a group of gold, silver, copper, nickel, aluminum, and palladium; a metal particle or fiber the surface of which is plated with gold, palladium, or silver; or a resin core ball having a resin ball plated with nickel, gold, palladium, or silver.

Another aspect of the present disclosure is a method for forming a conductive pattern comprising, a step of forming a conductive pattern by performing pattern printing of the above conductive resin composition for microwave heating onto a substrate, and a step of heating and curing the conductive pattern by microwave irradiation.

A conductive resin composition for microwave heating according to the present disclosure contains an appropriate amount of carbonaceous material having a predetermined shape, together with a conductive filler which is not carbonaceous, and an insulating binder resin which can be cured, and thus, when the composition is heated by microwave, generation of sparks can be suppressed, the composition can be cured in a short time, and a superior productivity of a low-resistant conductive pattern can be obtained.

### BRIEF DESCRIPTION OF DRAWINGS

FIG. 1 is a plan view of a cut piece according to an example.

FIG. 2 is a schematic cross-sectional view explaining a test piece securing method according to an example.

### ASPECT OF DISCLOSURE

Hereinbelow, an aspect of the present disclosure (hereinbelow, referred to as an aspect) will be explained.

A conductive resin composition for microwave heating according to the present aspect (hereinbelow, may be referred to as a conductive resin composition) contains a non-carbonaceous conductive filler, a curable insulating resin functioning as a binder resin, and a carbonaceous material having a higher volume resistivity value than the non-carbonaceous conductive filler.

The non-carbonaceous conductive filler is preferably a particle or a fiber made of at least one kind of metal, or an alloy of a plurality of kinds of metal selected from a group of gold, silver, copper, nickel, aluminum, and palladium; a metal particle or fiber the surface of which is plated with gold, palladium, or silver; or a resin core ball having a resin ball plated with nickel, gold, palladium, or silver. However, the non-carbonaceous conductive filler is not limited to these, and can be other non-carbonaceous material as far as the conductivity can be obtained, and the adhesive property is not largely damaged (too large to be used as an adhesive). From the viewpoint of conductivity, a volume resistivity value is preferably less than 10⁻⁴ Ω·cm at 20° C. By way of example, at 20° C., a volume resistivity value of gold is 2.2 μΩ·cm, that of silver is 1.6 μΩ·cm, that of copper is 1.7 μΩ·cm, that of nickel is 7.2 μΩ·cm, that of aluminum is 2.9 μΩ·cm, and that of palladium is 10.8 μΩ·cm. The shape of the conductive filler is not limited. In case of a particle, the shape can be various such as spherical, plate-like (flat), rod-shape, etc. The particle diameter is preferably in the range of 0.5 μm to 20 μm, and more preferably from 0.7 μm to 15 μm. Here, the particle diameter is the number median particle diameter D50 (median diameter), obtained by measuring diameters using laser diffraction-scattering. In case of a fiber, a fiber having a diameter of 0.1 μm to 3 μm, a length of 1 μm to 10 μm, and an aspect ratio (average length/average diameter) of 5 to 100, is preferable. The content of the non-carbonaceous conductive filler is preferably 25 to 90% by mass, more preferably 40 to 85% by mass, and still more preferably 60 to 80% by mass, relative to the total amount of the non-carbonaceous conductive filler and the curable insulating binder resin.

The binder resin is a curable resin, and can be any known curable insulating resin such as, an unsaturated polyester resin including an epoxy resin, a vinyl ester resin, a polyurethane resin, a silicone resin, a phenolic resin, an urea resin, a melamine resin, and the like. In the present specification, the “binder resin” includes a monomer having a curing property. The binder resin is preferably liquid at ordinary temperature, but the one which is solid at ordinary temperature can also be used by dissolving the solid resin in an organic solvent and make the resin into a liquid form.

Examples of the carbonaceous material are graphite, graphene, fullerenes (buckminsterfullerene, carbon nanotube, carbon nanohorn, carbon nanobud)), glassy carbon, amorphous carbon, carbon nanofoam, activated carbon, carbon black, charcoal, carbon fiber, and the like. Preferably, these are added in a powder form. The use of powder having an aspect ratio of 20 or less may promote the curing of the curable resin by microwave heating mentioned below. The aspect ratio is more preferably 15 or less, and still more preferably 10 or less. When a carbonaceous material having a high aspect ratio is used, the dispersion property of the carbonaceous material in the conductive resin composition tends to decrease, and thus, sparks may be more easily generated at the time of microwave heating. Here, the aspect ratio means average length/average diameter for a fiber-shape material, average major diameter/average minor diameter for an elliptical material, and average width/average thickness for a plate-like (flat) material.

The carbonaceous material absorbs the microwave (energy) more easily, compared to the materials other than the carbonaceous material (the non-carbonaceous conductive filler, the binder resin, and additives such as a solvent which is mixed in accordance with needs), among the materials composing the conductive resin composition. Therefore, the generation of sparks at the time of microwave irradiation can be suppressed, and efficient heating can be performed. According to the present disclosure, the carbonaceous material is not used as a component providing conductivity, namely, is not used as a conductive filler. The carbonaceous material contained in the conductive resin composition according to the present disclosure has a higher volume resistivity value compared to the conductive filler, i.e., has a volume resistivity value at 20° C. of 10⁻⁴ ≠·cm or more.

The carbonaceous material is contained 1 to 20 parts by mass, preferably 2 to 15 parts by mass, and more preferably 3 to 10 parts by mass, relative to the total of 100 parts by mass of the non-carbonaceous conductive filler and the binder resin in the conductive resin composition. When the content is less than 1 part by mass, the effect of suppressing the spark generation is small. When the content exceeds 20 parts by mass conductivity of the cured object of the conductive resin composition is decreased.

The content of the binder resin in the conductive resin composition is preferably 10 to 50% by mass, more preferably 15 to 40% by mass, and still more preferably 20 to 30% by mass, relative to the total amount of the components constituting the cured object, i.e., the components constituting the conductive resin composition but excluding the solvent mixed in accordance with needs, in view of the printability and the conductivity of the cured conductive layer.

The conductive resin composition for microwave heating according to the present aspect can be prepared to have an appropriate viscosity in accordance with the printing method or a coating method to elements, substrates, etc., by selecting the type and the amount of the non-carbonaceous conductive filler, the curable binder resin, and the carbonaceous material, and by using a diluent in accordance with needs. For example, in case of screen printing, using an organic solvent having the boiling point of 200° C. or more, as a diluent, is preferable. Such an organic solvent may be diethylene glycol monomethyl ether acetate, diethylene glycol monobuthyl ether acetate, diethylene glycol monobuthyl ether, terpineol, and the like. Although depending on a printing method or a coating method, in case of screen printing, the viscosity of the conductive resin composition measured by an E-type viscometer (3° cone, 5 rpm, 1 min value, 25° C.) is preferably in the range of 5 Pa·s to 1000 Pa·s, and more preferably in the range of 10 Pa·s to 500 Pa·s.

In addition to the above components, the conductive resin composition for microwave heating according to the present aspect may contain a dispersion aid, in accordance with needs. The dispersion aid may be an aluminum chelate compound such as diisopropoxy (ethyl acetoacetate) aluminum; titanate ester such as isopropyl triisostearoyl titanate; aliphatic polyvalent carboxylic acid ester; an unsaturated fatty acid amine salt; surfactant such as sorbitan monooleate; or a polymer such as polyester amine salt, polyamide, etc. Further, inorganic and organic pigment, a silane coupling agent, a leveling agent, a thixotropic agent, an antifoaming agent, may also be mixed.

The conductive resin composition for microwave heating according to the present aspect may be prepared by uniformly mixing the mixture components by a mixing device such as an automated mortar, propeller agitator, kneader, roll, pot mill, etc. The preparing temperature is not particularly limited, and can be an ambient temperature.

The conductive resin composition for microwave heating according to the present aspect can be printed or coated to have a predetermined pattern on a substrate by any selected method, such as screen printing, gravure printing, dispensing, etc. The predetermined pattern includes the entire-surface printing by which the printing is performed on the entirety of the substrate surface. When an organic solvent is used as a diluent, after the printing or coating, the organic solvent is volatized at an ambient temperature or by heating.

Then, the conductive resin composition is subjected to microwave irradiation by an appropriate device, to efficiently cure the curable resin and form a conductive pattern on a required portion of the substrate surface. In this case, the carbonaceous material mainly absorbs the microwave and undergoes internal heat generation, and the binder resin is cured by the generated heat. In addition, because the microwave is efficiently absorbed by the carbonaceous material, generation of sparks in the conductive resin composition at the time of microwave irradiation can be suppressed. Due to the microwave irradiation, the binder resin in the conductive resin composition is cured to cause volume contraction, and the solvent, i.e., an optional component, is vaporized. Thereby, the conductive fillers in the conductive resin composition become strongly in contact to each other, the cured object presents and maintains conductivity.

Here, the microwave is an electromagnetic wave having an wavelength in the range of 1 m to 1 mm (frequency being 300 MHz to 300 GHz). The method for the microwave irradiation is not limited, but, for example, irradiating microwave while a substrate surface provided with a conductive resin composition film is maintained to be substantially parallel with the direction of the line of electric force (direction of electric field) is preferable from the viewpoint of suppressing the generation of sparks. Here, the substantially parallel refers to the state that the substrate surface is maintained to be parallel with the line of electric force or to have an angle of 30 degrees or less, relative to the line of electric force.

Accordingly, using the conductive resin composition for microwave heating according to the present aspect is printed on a substrate to have a predetermined pattern, and a semiconductor element, a solar panel, a thermoelectric element, a chip part, a discrete part, or a combination of these are aligned and mounted on the printed pattern, to thereby produce an electronic device. Further, the conductive resin composition for microwave heating according to the present aspect may be used to form a conductive pattern (for example, forming wiring of a film antenna, a keyboard membrane, a touch panel, RFID antenna) on a substrate and providing connection to the substrate, to thereby produce an electronic device.

### EXAMPLES

Hereinafter, specific examples of the present disclosure will be explained. The examples are described below for the purpose of easy understanding of the present disclosure, and the present disclosure is not limited to these examples.

### Example 1

0.7 g of UF-G10 (artificial graphite powder, average particle diameter: 4.5 μm (catalog value), aspect ratio=10, manufactured by Showa Denko K.K.) and 1.08 g of Terpineol (Terpineol C, manufactured by Nippon Terpene Chemicals, Inc.) were added to 7 g of XA-5554 (conductive adhesive, manufactured by Fujikurakasei Co., Ltd.) (10 parts by mass UF-G10, relative to 100 parts by mass of XA-5554). The obtained mixture was mixed well with a spatula, to prepare a material for printing (conductive resin composition). XA-5554 is composed of an epoxy resin jER828 manufactured by Mitsubishi Chemical Corporation (11.8 parts by mass), a reactive diluent GOT [low-viscosity epoxy resin] manufactured by Nippon Kayaku Co., Ltd. (7.9 parts by mass), a curing agent 2P4 MHZ manufactured by Shikoku Chemicals Corporation (1.5 parts by mass), silver powder AgC-GS manufactured by Fukuda Metal Foil & Powder Co., Ltd. (78.8 parts by mass). UF-G10 is a substantially flat particle, and the aspect ratio thereof was obtained by calculating an average width/average thickness of 20 particles arbitrary selected by SEM observation.

Using a circuit printing screen mask with line/space=400 μm/400 μm, pattern length=60 mm, and pattern width=7.6 mm, the above printing material was printed by screen printing to form a circuit pattern on one side of a polyimide film (Kapton (registered trademark) 200H, manufactured by Du Pont-Toray Co., Ltd.) having a film thickness of 50 μm. The polyimide film having the circuit pattern printed thereon, was cut to have a circuit pattern length of 10 mm and a circuit pattern width of 8 mm. The cut piece was arranged on the substantially center portion of a 125 μm-thick polyimide film (Kapton 500H, size: 34 mm×34 mm, manufactured by Du Pont-Toray Co., Ltd.) while the non-printed surface of the cut piece is in contact with the 125 μm-thick polyimide film, and fixed by Kapton tape (Kapton Tape 650S#25, thickness: 50 μm, manufactured by Teraoka Seisakusho Co., Ltd.), to prepare a test piece.

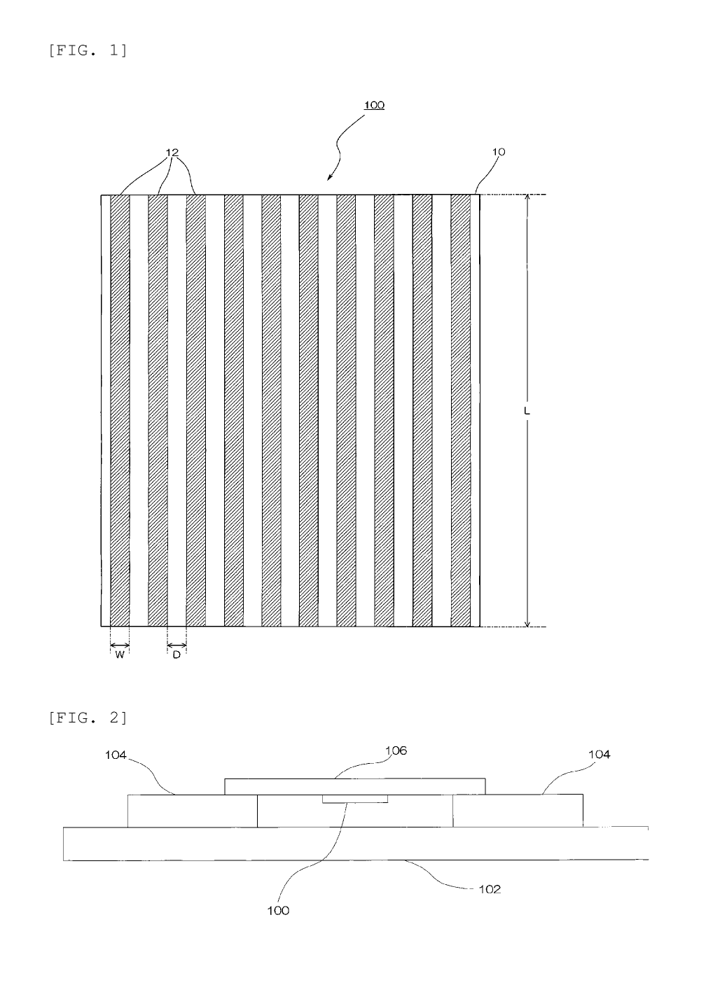

FIG. 1 shows a plan view of the cut piece. In FIG. 1, the cut piece 100 has a polyimide substrate 10 on which lines 12 are printed to be in parallel with each other. The line 12 has a length L of 10 mm, and a width W of 400 μm. The distance D between the lines 12 is also 400 μm. In the cut piece 100 exemplified in FIG. 1, ten lines 12 are formed, but the number of lines is not limited thereto, and can be any appropriate number. As mentioned above, the cut piece 100 shown in FIG. 1 was fixed on a polyimide film (not shown) with the Kapton tape, while the non-printed surface of the cut piece was in contact with the polyimide film. Thereby, a test piece was formed.

FIG. 2 shows a schematic cross-sectional view explaining a method for fixing the test piece. The sizes of the figure is not accurate. In FIG. 2, quartz plates (length 14 mm×width 35 mm×thickness 2 mm) 104 functioning as spacers were arranged on a quartz plate (length 100 mm×width 35 mm×thickness 2 mm) 102, so that the quartz plates 104 were separated from the center of the quartz plate 102 to the right and left directions by 13 mm. The test piece 106 on which the cut piece 100 was fixed, was adhered and fixed onto the quartz plates 104 functioning as spacers, with the Kapton tape, in a way so that the printed surface of the cut piece 100 was faced downward (in the direction of the quartz plate 102) and the cut piece 100 (printed portion) was located at substantially the center of the quartz plates 104, i.e., the spacers.

Next, the quartz plate 102 to which the test piece 106 was fixed, was inserted in an applicator of a microwave heating device (pulse-type heating device FSU-501VP-07, manufactured by Fuji Electronic Industrial Co., Ltd.). While the temperature displayed on a radiation thermometer was watched, microwave was irradiated in the vertical direction toward the paper face of FIG. (from the back to the front, or from the front to the back, of the paper face), and heating was started at the output power of 10 W. The electric power value was gradually raised, and was adjusted so that the strength of the standing wave was kept at the maximum. The heating was performed so that the display temperature of the radiation thermometer measuring the circuit pattern portion printed on the cut piece 100 was raised to 150° C. after approximately eight minutes. Thereafter, the temperature of 150° C. was kept for 30 seconds (total heating time: 8.5 minutes), and then, the heating was stopped. No sparks were generated during the heating. The radiation thermometer measured the temperature of the projected portion of the line 12, on the upper side (the side opposite to the printed surface) of the test piece 106. The temperature of this portion is not the temperature of the line 12 itself, but is treated as substantially identical with the temperature of the line 12.

After the treatments were complete, the circuit pattern portion had a thickness of 24 μm. The measurement value of the resistance value between the 10 mm in the length direction of the pattern (line 12) of the cut piece 100, measured by Digital Multimeter (TY520, manufactured by Yokogawa Meters & Instruments Corporation) was 2.0Ω.

### Examples 2 to 5, Comparative Examples 1 and 2

As shown in Table 1, printing materials (conductive resin compositions) were prepared in the same way as Example 1, except that added amounts of UF-G10 and terpineol were changed. Using each of the printing materials, a circuit pattern was printed by screen printing on a polyimide film, which was subjected to microwave heating and resistance value measurement, in the same way as Example 1. The results are shown in Table 1.

### Comparative Example 3

As shown in Table 1, a printing material (conductive resin composition) was prepared in the same way as Example 4, except that carbon nanotube (VGCF (registered trademark)-H, aspect ratio=40, manufactured by Showa Denko K.K.) was used as a carbonaceous material, instead of UF-G10. Using the prepared printing material, a circuit pattern was printed by screen printing on a polyimide film, which was subjected to microwave heating and resistance value measurement, in the same way as Example 4. The circuit pattern portion had a thickness of 25 μm, and a resistance value of 13.7Ω. VGCF-H had a substantially fiber shape, the aspect ratio thereof was obtained by calculating an average length/average diameter of 20 particles arbitrary selected by SEM observation.

### Comparative Example 4

The test piece was prepared in the same way as Example 1, except that an oven (DASK-TOP TYPE HI-TEMP. CHAMBER ST-110, manufactured by ESPEC Corporation) was used for heating instead of the microwave heating device, and heating was performed at 150° C., for 30 minutes. The resistance value was measured in the same way as Example 1. The circuit pattern portion had a thickness of 28 μm, and a resistance value of 3.3Ω.

The result of the Comparative Example 4 is also shown in Table 1.

TABLE 1

| | | | | | Amount of Added | | | | |
|---|---|---|---|---|---|---|---|---|---|
| | | | | | Carbonaceous | | | | |
| | Prepared Raw | | | | Material | | | Resistance | |
| | Material Amount (g) | | | | (part by mass)* | | | Value | Spark |
| | XA-5554 | UF-G | VGCF-H | Terpineol | UF-G | VGCF-H | Heating Method | (Ω) | Generation |
| Example 1 | 7 | 0.7 | 0 | 1.08 | 10 | 0 | microwave | 2.0 | N |
| | | | | | | | 8.5 min. | | |
| Example 2 | 7 | 1.05 | 0 | 1.4 | 15 | 0 | microwave | 4.8 | N |
| | | | | | | | 8.5 min. | | |
| Example 3 | 7 | 0.35 | 0 | 0.68 | 5 | 0 | microwave | 1.1 | N |
| | | | | | | | 8.5 min. | | |
| Example 4 | 7 | 0.14 | 0 | 0.4 | 2 | 0 | microwave | 1.1 | N |
| | | | | | | | 8.5 min. | | |
| Example 5 | 7 | 1.4 | 0 | 2 | 20 | 0 | microwave | 7.8 | N |
| | | | | | | | 8.5 min. | | |
| Comparative Example 1 | 7 | 0 | 0 | 0.32 | 0 | 0 | microwave | 1.5 | Y |
| | | | | | | | 8.5 min. | | |
| Comparative Example 2 | 7 | 1.75 | 0 | 2.52 | 25 | 0 | microwave | 14.8 | N |
| | | | | | | | 8.5 min. | | |
| Comparative Example 3 | 7 | 0 | 0.14 | 0.4 | 0 | 2 | microwave | 13.7 | Y |
| | | | | | | | 8.5 min. | | |
| Comparative Example 4 | 7 | 0.7 | 0 | 1.08 | 10 | 0 | oven | 3.3 | — |
| | | | | | | | 150° C. | | |
| | | | | | | | 30 min. | | |

*Added amount relative to the total of 100 parts by mass of non-carbonaceous conductive filler and binder resin

As shown in Table 1, in Examples 1 to 5, the microwave heating could be performed without generating any sparks, and resistance values of the circuit pattern were less than 10Ω, which were sufficiently low.

On the other hand, in Comparative Example 1, sparks were generated during the microwave heating, and a part of the substrate was burned. This occurred because the artificial graphite powder (UF-G10) was not added to the conductive resin composition, and the energy of the microwave could not be efficiently absorbed.

In Comparative Example 2, too much amount of the artificial graphite powder (UF-G10) was added, and thus, the resistance value became too high, and the performance as a conductive resin composition was reduced.

In Comparative Example 3, because the carbonaceous material had a too large aspect ratio, sparks were generated, the resistance value became too high, and the performance as a conductive resin composition was reduced.

In Comparative Example 4, heating should be performed for minutes in order to decrease the resistance value of the circuit pattern (3.3Ω). Thus, the productivity is low compared to the case that the microwave heating is used.

### Explanation of Numerals

10 polyimide substrate, 12 line, 100 cut piece, 102 quartz plate, 104 quartz plate as spacer, 106 test piece

1. A conductive resin composition for microwave heating comprising a non-carbonaceous conductive filler, a curable and insulating binder resin, and a carbonaceous material having a higher volume resistivity value than the non-carbonaceous conductive filler, the carbonaceous material having an aspect ratio of 20 or less, and the content of the carbonaceous material being 1 to 20 parts by mass, relative to the total of 100 parts by mass of the non-carbonaceous conductive filler and the curable and insulating binder resin.

2. A conductive resin composition for microwave heating according to claim 1, wherein the carbonaceous material is graphite.

3. A conductive resin composition for microwave heating according to claim 1, wherein the non-carbonaceous conductive filler is a particle or a fiber made of at least one kind of metal, or an alloy of a plurality of kinds of metal selected from a group of gold, silver, copper, nickel, aluminum, and palladium; a metal particle or fiber the surface of which is plated with gold, palladium, or silver; or a resin core ball having a resin ball plated with nickel, gold, palladium, or silver.

4. A method for forming a conductive pattern comprising, a step of forming a conductive pattern by performing pattern printing of a conductive resin composition for microwave heating according to claim 1, onto a substrate, and a step of heating and curing the conductive pattern by microwave irradiation.
